(19) United States
(12) Patent Application Publication
(10) Pub. No.: US 2004/0212718 A1
(43) Pub. Date: Oct. 28, 2004

(54) Placement of a camera module in a portable device

(75) Inventors: Jari Hiltunen, Siuro (FI); Janne Haavisto, Kangasala (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/760,120

(22) Filed: Jan. 16, 2004

(30) Foreign Application Priority Data
Jan. 17, 2003 (FI) 20030071

(51) Int. Cl. H04N 5/225

(52) U.S. Cl. 348/340

(57) ABSTRACT

A portable electronic device, which comprises at least a camera module and a printed wiring board for placing the camera module and other structures. The camera module comprises an optics zone comprising an input aperture, and a connector zone, which comprises contacts for connecting the camera module to counter-contacts. In the device, the optics zone and the connector zone of the camera module are placed on different sides of the printed wiring board. In addition, the invention comprises a camera module, a frame structure, a printed wiring board, a combination of a frame structure and a printed wiring board, and a method for placing the camera module in a portable device.

### CROSS-REFERENCE TO RELATED APPLICATIONS

This application claims priority under 35 USC §119 to Finnish Patent Application No. 20030071 filed on Jan. 17, 2003.

### FIELD OF THE INVENTION

The invention relates to a portable electronic device having a camera module. The invention also relates to a method for placing a camera module in a portable electronic device. In addition, the invention relates to a printed wiring board, PWB, for installing a camera module, a printed wiring board and a connected frame structure for installing a camera module. The invention also relates to a frame structure to be placed on a printed wiring board for placing a camera module. It further relates to a camera module to be placed on a printed wiring board.

### BACKGROUND OF THE INVENTION

With some mobile devices it is possible to take digital pictures of the surroundings, which pictures can, in some applications, be transferred to other devices via a mobile communication network. In order to take pictures, the device must include a camera function, which typically comprises a camera module and the necessary image processing means. The camera modules, for their part, typically comprise optical structures and electric structures. The optics of a camera module can consist of one or more lenses, which form, through an input aperture, a visible image on a suitable electronic means, such as a CCD cell (charge-coupled-device) or a CMOS cell (Complementary Metal Oxide Semiconductor). In addition, the optics of a camera module may comprise other parts, which affect the formation of the image, such as, for example, an aperture diaphragm.

Typically the camera module is installed on a printed wiring board after the assembly and soldering of other components, because of the thermal stability of the materials typically used in the camera modules, which in many cases is smaller than the temperature used in the connection process of other components. In the known camera module structures meant to be installed in printed wiring boards, there are contacts for connecting the camera, typically either at the end of a flexible structure (a so-called flex-type connection), or the contacts are at the bottom of the camera module, i.e. on the opposite side of the lens structure of the module.

In a flex-type structure, wherein the contacts of the connector are placed at the ends of a flexible structure, it is possible to form a relatively small module, when the connection means are placed elsewhere. The frame part of a camera module is attached to the remaining structure of the device typically by gluing. The flex-type structure suits a quick-tempo assembly poorly because of, among other things, the characteristics of a flexible connection structure and the attachment work required by both the frame part and connector structure.

The camera modules, wherein the contacts are located at the bottom of the module, are placed on a printed wiring board typically by means of a separate connector part. Thus, the connector part is placed and connected on the printed wiring board simultaneously with other components. After a working phase that needs heat transfer, a camera module, whose connectors correspond to the contacts of the connector part, is installed in the frame. Thanks to a separate connector part, the camera module is easily detached and, if necessary, changed. On the other hand, the connector part situated between the camera module and printed wiring board increases the height of the structure.

From a Japanese publication JP2002185827A is known a camera structure, wherein the connectors to be placed against the printed wiring board are at the bottom. The structure according to the publication makes it possible to install a camera module on a printed wiring board without a separate connector part, because of which it is possible to make the structure of the component even lower. As a result of the lack of a separate connector part, replacing the component is, for example during maintenance, more troublesome than with solutions carried out with a connector part.

### SUMMARY OF THE INVENTION

The main purpose of the present invention is to disclose a camera module structure, which enables a low overall structure.

To attain this purpose, the present invention is directed to a portable electronic device, which comprises at least a camera module, which comprises at least an optics zone, which comprises at least an input aperture and a connector zone, which comprises at least contacts for connecting the camera module to counter-contacts, and a printed wiring board, which includes parallel first and second sides for placing the camera module and other structures, wherein the optics zone and the connector zone of the camera module are settled on different sides of the printed wiring board.

The invention further relates to a method for placing a camera module in a portable electronic device, wherein the camera module, which comprises at least an input aperture and a connector zone, is arranged on a printed wiring board, where other structures of the device are also placed, wherein the input aperture of the camera module settles on a different side of the printed wiring board than the connector zone.

In addition, the invention relates to a printed wiring board for installing a camera module, wherein there is an aperture in the printed wiring board, at least part of the camera module can be placed through the aperture of the printed wiring board, and contacts between the camera module and the printed wiring board are arranged to form electrical contact when the camera module is in place. The invention further relates to a printed wiring board and a frame structure connected to it for installing a camera module, wherein there is an aperture in the printed wiring board, and in addition there is an aperture in the frame structure, which is on the side placed against the printed wiring board, and said apertures are placed in such a manner that at least a part of the camera module can be placed through the aperture of the frame structure to the aperture of the printed wiring board. The invention also relates to a frame structure to be placed on a printed wiring board for placing a camera module, which frame structure comprises at least contacts for connecting the camera module, and an installation aperture on the first side for placing the camera module in the frame structure, wherein there is an aperture on the other side of the frame structure, which is in connection with the installation aperture. The invention also relates to a camera module to be placed on a printed wiring board, which camera module comprises at least an optics zone, which comprises at least an input aperture and a connector zone, which comprises at least contacts for connecting the camera module to counter-contacts, and the direction of function of which camera module is substantially the same as the direction of the input aperture from the connector zone, wherein the optics zone of the camera module can be placed at least partly through the printed wiring board and the contacts are placed in the connector zone on at least one side parallel with the direction of function of the camera module, or at least on the side of the light aperture of the optics zone, or at least one side parallel with the direction of function of the camera module and on the side of the light aperture of the optics zone.

The other, dependent claims will present some preferred embodiments of the invention.

In the solution according to the invention, the camera module can be installed on the printed wiring board in such a manner that the input aperture of the camera, i.e. typically a lens aperture, is on the other side of the printed wiring board from the connectors of the camera module. There must be an aperture in the printed wiring board, where the optics zone of the camera module can be placed. Preferably, the optics zone of the camera module is smaller by its diameter than the connector zone, in which case during installation the camera module leans on the widening of the connector zone. Preferably, the camera module is connected to an adapter part, wherein there are contacts corresponding to the contacts of the camera module. The adapter part is advantageously a frame-like structure, which settles on the level of the printed wiring board around the connector zone of the camera module. The contacts of the connector zone of the camera module settle, in the first embodiment according to the invention, on the printed wiring board side of the connector zone. In another embodiment, the contacts are located on one or more optical axis direction sides of the camera module.

In one advantageous embodiment according to the invention, the camera module can be easily installed in assembly and, if necessary, also after the other components have been attached. In addition, it is advantageous from the assembly point of view for the optics of the camera module to settle downwards, because then the risk of damage decreases significantly.

The invention makes it possible to form the device lower than before, because when the camera module settles on both sides of the printed wiring board, the camera module utilizes the space required for installing other components, as well as the space required by the thickness of the printed wiring board. The advantage becomes especially apparent in those applications of the embodiments, wherein the camera module is one of the largest components placed on the printed wiring board and other components are placed on both sides of the printed wiring board.

In some embodiments of the invention, the camera module is easily protected from mechanical and electrical interferences. It is possible to easily encase the camera module from the connector side, because no lead-ins or other special structures are required for the optics and the back surface of the module is substantially even.

A camera module according to the invention is easily supported, because the springback factor of the spring-like connectors on the sides of the connector zone can be used to press the module towards the printed wiring board.

### DESCRIPTION OF THE DRAWINGS

In the following, the invention will be described in more detail with reference to the principle drawings, in which

FIG. 1 shows a frame structure according to an embodiment of the invention in a side view,

FIG. 2 shows an embodiment of a camera module according to FIG. 1 from the lens aperture side,

FIG. 3 shows a frame structure according to another embodiment of the invention in a side view,

FIG. 4 shows an embodiment of a camera module according to FIG. 3 from the lens aperture side,

FIG. 5 shows a frame structure according to a third embodiment of the invention in a side view, and

FIG. 6 shows a frame structure according to a fourth embodiment of the invention in a side view.

### DETAILED DESCRIPTION OF THE INVENTION

For the sake of clarity, the figures only show the details required for understanding the invention. The structures and details which are not necessary for understanding the invention but which are obvious for anyone skilled in the art, have been omitted from the figures in order to emphasize the characteristics of the invention.

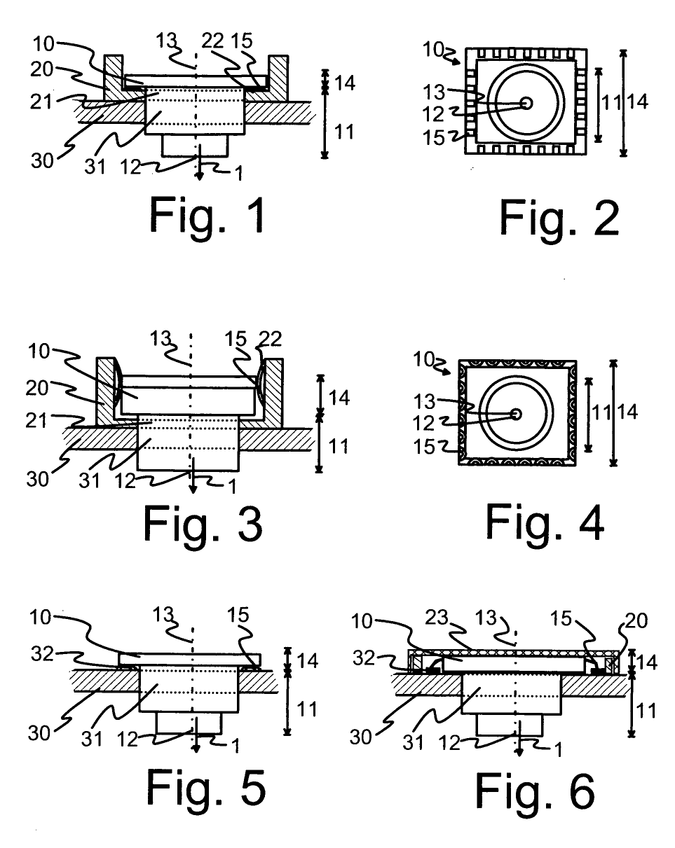

In an advantageous embodiment of the invention, the camera module 10 is placed in a frame 20 arranged on the printed wiring board 30, and other components required in the device are also arranged on the same printed wiring board, such as components required for data transfer or data editing in a mobile device. Some camera module structures 10 and frame structures 20 according to the embodiment in question are shown in FIGS. 1-4 in principle.

The camera module 10 comprises different functional components, which in this description are referred to as zones. In addition to the optics zone 11 and the connector zone 14, the camera module 10 comprises other zones and components, such as a CCD cell or a CMOS cell, which are not separately shown in the figures.

The optics zone 11 comprises, for optical forming of an image, at least a lens structure opening to the direction of function 1 through an input aperture 12, which structure can consist of one or more lenses. The input aperture 12 here refers to the foremost free area of an optical component, which may be an aperture or the surface of a lens. Through the input aperture 12, i.e. typically the lens aperture, runs a so-called optical axis 13, which is parallel to the direction of function 1 of the camera module 10, from the recorded object through the lens structure to the image sensor, i.e. typically a CMOS cell or CCD cell.

In order to transfer data between the camera module 10 and other equipment, there is a connector zone 14 in the camera module. The connector zone 14 comprises at least contacts 15, with which the camera module 10 is electrically connected to the electric circuit of the rest of the equipment. In addition, in the connector zone 14 there can advantageously be elements for mechanical attachment of the camera module 10, which elements are preferably the same elements as the contacts 15 meant for electric connection. The number of contacts 15 depends mostly on the characteristics of the cell of the camera module 10, and this invention is not dependent on the number of contacts.

The camera module 10 according to the invention is placed according to the invention into the frame 20 connected to the printed wiring board 30 in such a manner that the optics zone 11 of the camera module settles substantially inside the frame and through the printed wiring board. Thus, the frame 20 comprises at least an aperture 21 for the optics zone 11, as well as counter-contacts 22 corresponding to the contacts 15 of the camera module 10 and connection elements for connecting to the printed wiring board 30. In addition, there can advantageously be elements for mechanical attachment of the camera module 10 in the frame 20, which elements are preferably the same elements as the counter-contacts 22.

The printed wiring board 30 is typically multi-layered, but the structure of the printed wiring board can vary extensively without the basic idea of the invention changing. The frame 20 according to the invention is connected to the printed wiring board 30 in such a manner that the aperture 21 of the frame and the aperture 31 in the printed wiring board are aligned, in which case the optical axis 13 of the camera module 10 can be arranged through the apertures in question, in which case the direction 1 of function of the camera module forms on the other side of the printed wiring board, while the frame settles on the first side of the printed wiring board. In addition, other components and elements required in the equipment, which are typically placed on both sides of the printed wiring board, are connected to the printed wiring board 30.

The contacts 15, 22 of the camera module 10 according to the invention and the frame 20 can be formed in many different ways. Preferably the contacts 15, 22 are arranged according to either image pair of FIGS. 1 and 2 or FIGS. 3 and 4.

In one embodiment of the invention presented in FIGS. 1 and 2, the contacts 15, which are on a perpendicular plane in relation to the optical axis 13 of the camera module 10, are on the side of the optics zone 11 side of the connector zone 14. The contacts 15 can be formed according to the example on each side of the optical axis 13 of the camera module 10, or there can be contacts on one or more sides.

Thus, the counter-contacts 22, which settle against the contacts 15 of the camera module 10 of the frame 20, are according to FIG. 1 on the same plane, which is substantially parallel to the plane formed by the printed wiring board 30.

The contact elements 15, 22 of both the camera module 10 and the frame 20 can be implemented in several different ways. It is, however, advantageous, that either the contacts 15 of the camera module 10, or preferably the counter-contacts 22 of the frame 20, are flexible, such as clip-like, in which case there is loading force between the contacts of the camera module and the frame. Thus, the electric connection between the camera module 10 and the frame 20 remains during the possible temporary shifts of the components as well, such as, for example, during the effect of outside vibration.

In another embodiment of the invention shown on FIGS. 3 and 4, the contacts 15 of the camera module 10 are on the sides parallel to the direction of the optical axis 13 of the connector zone 14. Also in this embodiment, the contacts 15 can be on one or more sides, for example on every side parallel to the direction of the optical axis 13 according to the example in FIG. 4. In this embodiment as well, the contact elements 15, 22 of the camera module 10 and the frame 20 can be implemented in several different ways. It is, however, advantageous, because of the reasons presented in connection with the previous embodiment, that either the contacts 15 of the camera module 10 or preferably the counter-contacts 22 of the frame 20 are flexible, such as clip-like, in which case there is loading force between the contacts of the camera module and the frame. In addition, in the embodiment in question, it is possible to utilize said loading force in keeping the camera module 10 in place. Preferably the counter-contacts 22 of the frame 20 are arranged on each side in such a manner that the loading force created by their spring-like structure is aimed at the camera module 10 in such a manner that a force pressing the module towards the printed wiring board 30 is aimed at it.

A combination of the above-presented contact arrangements 15, 22 is also possible and the manner in question is advantageous when considerably many contacts are required in the camera module 10.

An embodiment according to the invention is shown in FIG. 5. In the example in question, the camera module 10 is substantially the same as the camera module 10 in FIG. 1, i.e. the contacts 15 of the camera module are on the side of the optics zone 11 of the connector zone 14 on a perpendicular plane in relation to the optical axis 13 of the camera module 10. The counter-contacts 22 of the frame 20 presented in FIG. 1 are, in this embodiment, arranged directly on the printed wiring board 30. Thus, the contacts 15 of the camera module 10 settle against the counter-contacts, which in this embodiment are the counter-contacts 32 arranged to the printed wiring board 30. Attachment of the camera module 10 can be implemented, for its part, in several different ways, such as, for example, by gluing or with an appropriate attachment element.

Another embodiment according to the invention is shown in FIG. 6. In the example in question, the contact 15 of the camera module 10 is in the connector zone 14 at the end of a lead coming out from the component body, i.e, package. The contact surface of the contact 15 is placed in the connector zone 14 on the optics zone 11 side on a perpendicular plane in relation to the optical axis 13 of the camera module 10. Thus, the contacts 15 of the camera module 10 settle against the counter-contacts, which in this embodiment are the counter-contacts 32 arranged to the printed wiring board 30, just as in the previous example. The contacts 15 of the camera module 10 are attached to the counter-contacts 32 in an appropriate manner, such as, for example, by soldering or by gluing. In an embodiment the contacts 15 of the camera module 10 are spring-like, in which case the attachment can be implemented with a springback factor. Thus, the camera module 10 is placed in its position in such a manner that the contacts 15 of the camera module are pressed against the counter-contacts 32. Attachment of the camera module 10 can be implemented in several different ways as well, such as, for example, by gluing or with an appropriate attachment element. In an embodiment the attachment of the camera module 10 is implemented by means of a protective shell 23. Thus, the protective shell 23 attaches to a wiring board 30 either directly or by means of a frame 20, in which case the camera module settling between the protective shield and the wiring board remains in its position.

In the placement of the contacts 15, 22, 32 according to the invention there are no contacts on the opposite side in the direction 1 of the function of the camera module 10 (i.e. the light aperture 12). Thus, the protection of the camera module 10 against electromagnetic radiation is easy to implement. The protection can be implemented either as a part of the camera module 10 and the frame 20, or the protection can be arranged with a separate protection element, such as a protective shell 23 or a protective plate. An advantageous manner, from the point of view of assembly, is to form the frame 20 from such suitable material, which limits the electromagnetic interference radiation. Those areas of the camera module 10, which settle outside the possible frame 20 when the camera modules are fitted to the frame, are, for their part, advantageous to coat or otherwise form of a material which attenuates radiation. Similarly, it is advantageous to coat or otherwise form of radiation attenuating materials parts of or the entire camera module 10 in the frameless embodiment presented in FIG. 5. Thus, in the assembly, the interference protection is formed without separate procedures during the installation of the components.

By combining, in various ways, the modes and structures presented in connection with the different embodiments of the invention presented above, it is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

What is claimed is:

1. A portable electronic device, which comprises at least a camera module, which comprises at least
an optics zone, which comprises at least an input aperture and
a connector zone, which comprises at least contacts for connecting the camera module to counter-contacts,
and a printed wiring board, which includes parallel first and second sides for placing the camera module and other structures, wherein the optics zone and the connector zone of the camera module are settled on different sides of the printed wiring board.

2. The device according to claim 1, wherein the printed wiring board comprises at least an aperture penetrating the printed wiring board, and the optics zone of the camera module is placed at least partly inside said aperture of the printed wiring board.

3. The device according to claim 1, wherein the device comprises, in addition, at least a frame structure, which comprises at least
contacts for connecting the camera module,
an aperture, which is on the side placed against the printed wiring board in the frame structure, and
the optics zone of the camera module is placed at least partly inside the aperture of the frame structure.

4. The device according to claim 1, wherein the device is arranged to transfer data in a wireless manner.

5. A method for placing a camera module in a portable electronic device, wherein the camera module, which comprises at least an input aperture and a connector zone, is arranged on a printed wiring board, where other structures of the device are also placed, wherein the input aperture of the camera module settles on a different side of the printed wiring board than the connector zone.

6. The method according to claim 5, wherein at least a part of the camera module is placed through the printed wiring board.

7. The method according to claim 6, wherein the camera module is arranged on the printed wiring board via the frame structure, and the printed wiring board comprises at least an aperture penetrating the printed wiring board, and the frame structure comprises at least an aperture on the side settling against the printed wiring board, and said apertures are placed one on the other in such a manner that the camera module can be placed at least partly inside the aperture of said printed wiring board and the aperture of said frame structure.

8. A printed wiring board for installing a camera module, wherein
there is an aperture in the printed wiring board,
at least part of the camera module can be placed through the aperture of the printed wiring board, and
contacts between the camera module and the printed wiring board are arranged to form electrical contact when the camera module is in place.

9. A printed wiring board and a frame structure connected to it for installing a camera module, wherein
there is an aperture in the printed wiring board,
in addition, there is an aperture in the frame structure, which is on the side placed against the printed wiring board, and
said apertures are placed in such a manner that at least a part of the camera module can be placed through the aperture of the frame structure to the aperture of the printed wiring board.

10. A printed wiring board and a frame structure connected to it according to claim 9, wherein there are contacts in the frame structure for connecting the camera module, which are placed on
at least the side parallel to the direction of the printed wiring board, or
at least one side, which is substantially perpendicular in relation to the printed wiring board, or
at least a first side parallel to the direction of the printed wiring board and a second side, which is substantially perpendicular in relation to the printed wiring board.

11. A frame structure to be placed on a printed wiring board for placing a camera module, which frame structure comprises at least
contacts for connecting the camera module, and
an installation aperture on the first side for placing the camera module in the frame structure,
wherein there is an aperture on the other side of the frame structure, which is in connection with the installation aperture.

12. The frame structure according to claim 11, wherein the contacts of the frame structure are placed on
at least the same side as the aperture, or
at least one side, which is substantially perpendicular to the side comprising the aperture, or
at least the same first side with the aperture and the second side, which is substantially perpendicular to the first side.

13. The frame structure according to claim 12, wherein at least one contact is arranged to function as a clamping device for the camera module.

14. A camera module to be placed on a printed wiring board, which camera module comprises at least
an optics zone, which comprises at least an input aperture and
a connector zone, which comprises at least contacts for connecting the camera module to counter-contacts,
and, the direction of function of which camera module is substantially the same as the direction of the input aperture from the connector zone, wherein the optics zone of the camera module can be placed at least partly through the printed wiring board and the contacts are placed in the connector zone on
at least one side parallel with the direction of function of the camera module, or
at least on the side of the light aperture of the optics zone, or
at least one side parallel with the direction of function of the camera module and on the side of the light aperture of the optics zone.

15. The device according to claim 2, wherein the device comprises, in addition, at least a frame structure, which comprises at least
contacts for connecting the camera module,
an aperture, which is on the side placed against the printed wiring board in the frame structure, and
the optics zone of the camera module is placed at least partly inside the aperture of the frame structure.

16. The method according to claim 5, wherein the camera module is arranged on the printed wiring board via the frame structure, and the printed wiring board comprises at least an aperture penetrating the printed wiring board, and the frame structure comprises at least an aperture on the side settling against the printed wiring board, and said apertures are placed one on the other in such a manner that the camera module can be placed at least partly inside the aperture of said printed wiring board and the aperture of said frame structure.

17. The frame structure according to claim 11, wherein at least one contact is arranged to function as a clamping device for the camera module.
